(19) United States
(12) Patent Application Publication
(10) Pub. No.: US 2013/0061108 A1
(43) Pub. Date: Mar. 7, 2013

(54) Self-Repair System and Method

(71) Applicant: Guobiao ZHANG, Corvallis, OR (US)

(72) Inventor: Guobiao ZHANG, Corvallis, OR (US)

(73) Assignee: CHENGDU HAICUN IP TECHNOLOGY LLC, ChengDu (CN)

(21) Appl. No.: 13/597,237

(22) Filed: Aug. 28, 2012

Related U.S. Application Data
(60) Provisional application No. 61/529,926, filed on Sep. 1, 2011.

(51) Int. Cl. G06F 11/16

(52) U.S. Cl. 714/752; 714/E11.054

(57) ABSTRACT

The present invention discloses a self-repair system for three-dimensional mask-programmed read-only memory (3D-MPROM). Most of the 3D-MPROM data are not checked in the factory, but checked and repaired in the field. This self-repair system comprises a playback device with a re-writable memory (RWM). The RWM temporarily stores new contents. After a user receives a 3D-MPROM card storing the same contents, the playback device checks the 3D-MPROM data. When bad data are detected, the good data to replace the bad data are fetched from the RWM.

### CROSS-REFERENCE TO RELATED APPLICATIONS

This application relates to a provisional application, “Self-Repair System and Method for Three-Dimensional Printed Memory”, Application Ser. No. 61/529,926, filed Sep. 1, 2011.

### BACKGROUND

1. Technical Field of the Invention

The present invention relates to the field of the integrated circuit, more particularly to mask-programmed read-only memory (mask-ROM).

2. Prior Arts

With the advent of three-dimensional mask-programmed read-only memory (3D-MPROM), the storage capacity of the mask-ROM greatly improves. U.S. Pat. No. 5,835,396 discloses a 3D-MPROM. It is a monolithic semiconductor memory. As illustrated in FIG. 1, a typical 3D-MPROM comprises a semiconductor substrate 0 and a 3-D stack 10 stacked above. The 3-D stack 10 comprises M (M≧2) vertically stacked memory levels (e.g. 10A, 10B). Each memory level (e.g. 10A) comprises a plurality of upper address lines (e.g. 2a), lower address lines (e.g. 1a) and memory cells (e.g. 5aa). Each memory cell stores n (n≧1) bits. Memory levels (e.g. 10A, 10B) are coupled to the substrate 0 through contact vias (e.g. 1av, 1av′). The substrate circuit 0X in the substrate 0 comprises a peripheral circuit for the 3-D stack 10. Hereinafter, xMxn 3D-MPROM denotes a 3D-MPROM comprising M memory levels with n bits-per-cell (bpc).

3D-MPROM is a diode-based cross-point memory. Each memory cell (e.g. 5aa) typically comprises a diode 3d. The diode can be broadly interpreted as any device whose electrical resistance at the read voltage is lower than that when the applied voltage has a magnitude smaller than or polarity opposite to that of the read voltage. The memory level 10A further comprises a data-coding layer 6A, i.e. a blocking dielectric 3b. It blocks the current flow between the upper and lower address lines. Absence or existence of a data-opening 6ca in the blocking dielectric 3b indicates the state of a memory cell. Besides the blocking dielectric 3b, the data-coding layer 6A could also comprise a resistive layer (referring to U.S. patent application Ser. No. 12/785,621) or an extra-dopant layer (referring to U.S. Pat. No. 7,821,080).

Inevitably, a manufactured mask-ROM contains faulty memory cells. In prior arts, a mask-ROM is factory-repaired, i.e. the data in the mask-ROM (i.e. the mask-ROM data) are checked and repaired in the factory. As illustrated in FIG. 2, this factory-repair process is carried out in a tester and comprises the following steps: read data at address A (step 61); check the data (step 63); if no bad data are detected, increment the address A (step 65); otherwise, fetch the good data for the address A from the tester (step 67), and write the address A and the associated good data to a redundancy ROM (step 69). Hereinafter, bad data refer to the data that are stored in the faulty memory cells and are un-correctable.

Factory-repair requires reading out all data in a mask-ROM. In the past, this is not difficult for the conventional mask-ROM, which stores a limited amount of data. However, this is very difficult for a large-capacity mask-ROM, more particularly for a 3D-MPROM. By way of example, it takes almost half a week to read out all data from a 3D-MPROM, which could store ˜1 TByte data but has a slow read speed of ˜3 MByte/s. In other words, its testing time will be almost half a week. Such a long testing time makes the factory-repair expensive for the large-capacity mask-ROM, more particularly for the 3D-MPROM.

### OBJECTS AND ADVANTAGES

It is a principle object of the present invention to provide a large-capacity mask-ROM, more particularly a 3D-MPROM, with a lower testing cost.

It is a further object of the present invention to provide a method to reduce the testing time and testing cost for a large-capacity mask-ROM, more particularly a 3D-MPROM.

In accordance with these and other objects of the present invention, self-repair system and method are disclosed.

### SUMMARY OF THE INVENTION

The present invention discloses self-repair system and method for a large-capacity mask-ROM, more particularly for a 3D-MPROM. The self-repair system comprises a playback device (e.g. cellular phone, internet TV, or computer) and a memory card containing 3D-MPROM (i.e. a 3D-MPROM card). Most of the 3D-MPROM data are not checked in the factory, but checked and repaired in the field, i.e. during the use of the playback device. A feature that distinguishes the present invention from prior arts is that the 3D-MPROM data are checked and repaired by a playback device, not by a tester. The playback device, which is a consumer device, is not on a par in price and complexity with a tester, which is an industrial equipment.

Self-repair takes advantage of an RWM (e.g. flash memory) that is part of the playback device and whose data can be erased and re-written. It also takes advantage of hybrid content-distribution. Hybrid content-distribution uses two types of memory to distribute contents: RWM and 3D-MPROM. During a publication period, new contents are transferred from a remote server to the playback device and saved into the RWM. At the end of the publication period, a user receives a 3D-MPROM card, which stores a collection of the transferred contents. An error-detecting means checks the data as they are read out from the 3D-MPROM. At this step, the RWM data are used as the correct version of the 3D-MPROM data. When bad data are detected, the good data to replace the bad data are fetched from the RWM and saved into a redundancy ROM. Self-repair can significantly reduce the testing time and lower the testing cost.

### BRIEF DESCRIPTION OF THE DRAWINGS

FIG. 1 is a cross-sectional view of a 3D-MPROM;

FIG. 2 discloses a factory-repair process for a mask-ROM in prior arts;

FIG. 3 discloses a preferred self-repair system and its communication with a remote server;

FIGS. 4A-4B illustrate two preferred playback devices;

FIG. 5 is a flow chart for a hybrid content-distribution method;

FIG. 6 discloses more details of the preferred self-repair system;

FIG. 7 discloses more details of the preferred self-repair method;

FIG. 8A-8B are cross-sectional views of two preferred memory card.

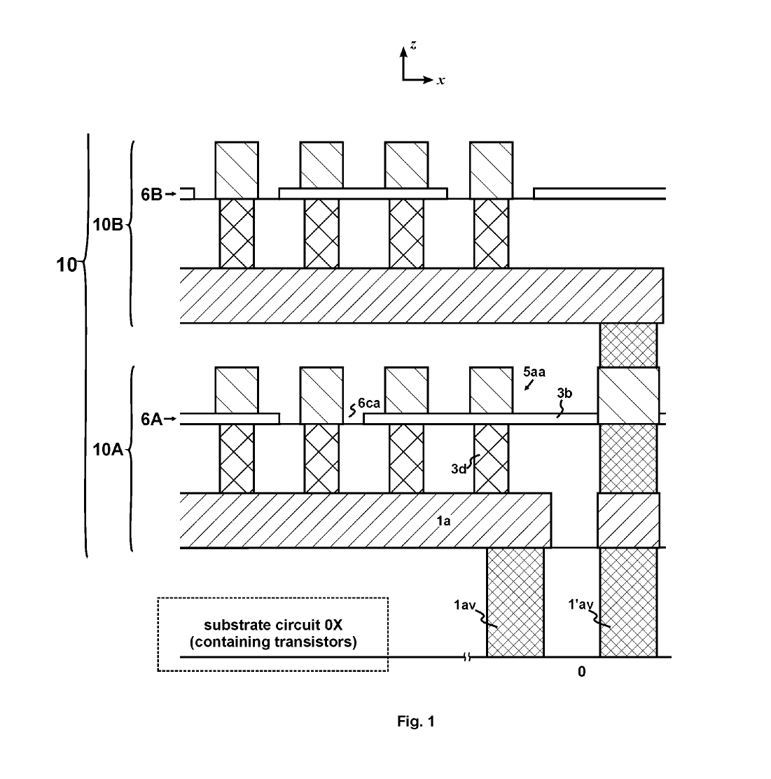

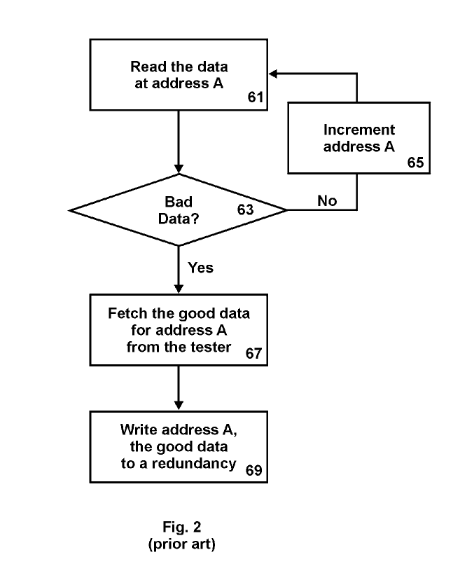

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

The present invention uses 3D-MPROM as an example to explain the concept of self-repair. The preferred embodiments disclosed herein can be extended to any large-capacity mask-ROM. A large-capacity mask-ROM has a storage capacity on the order of GB, even on the order of TB. In the present invention, the primary data-recording means for a mask-ROM includes photo-lithography and imprint-lithography. The “mask” in the mask-ROM includes data-mask used in photo-lithography, as well as nano-imprint mold or nano-imprint template used in imprint-lithography.

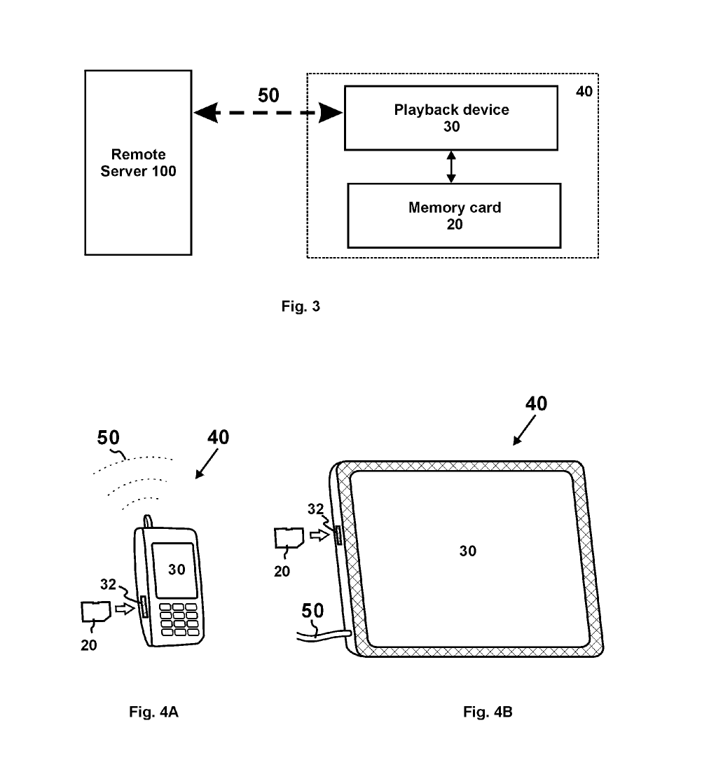

Referring now to FIG. 3, a self-repair system 40 and its communication channel 50 with a remoter server 100 are disclosed. The self-repair system 40 comprises a memory card 20 and a playback device 30. The memory card 20 could comprise a memory package or a memory module. It contains at least one 3D-MPROM die, more generally, at least one large-capacity mask-ROM die. The memory card 20 stores contents such as movies, video games, maps, music library, book library, and/or softwares.

The playback device 30, more generally, a consumer processing apparatus, can read and process data from the memory card 20, e.g. playing a movie or video game, reading a map, listening to music, reading books, or running software. The playback device 30 communicates with a remote server 100 through a communication channel 50. The remote server 100 stores a mass-content library. The communication channel 50 includes internet, WiFi and cellular (e.g. 3G, 4G) signals.

FIG. 4A illustrates a preferred playback device 30—a cellular phone. It communicates with the remote server 100 via cellular signals 50. The cellular phone 30 further comprises a slot 32 for holding the memory card 20, which can be inserted into or removed from the cellular phone 30. During the use of the cellular phone 30, the data in the memory card 20 will be checked and repaired. FIG. 4B illustrates another preferred playback device 30—an internet TV (or, a computer). It communicates with the remote server 100 via internet signals (including wired and wireless internet signals) 50. The internet TV (or, computer) 30 further comprises a slot 32 for holding the memory card 20, which can be inserted into or removed from the internet TV (or, computer) 30. During the use of the internet TV (or, computer) 30, the data in the memory card 20 will be checked and repaired.

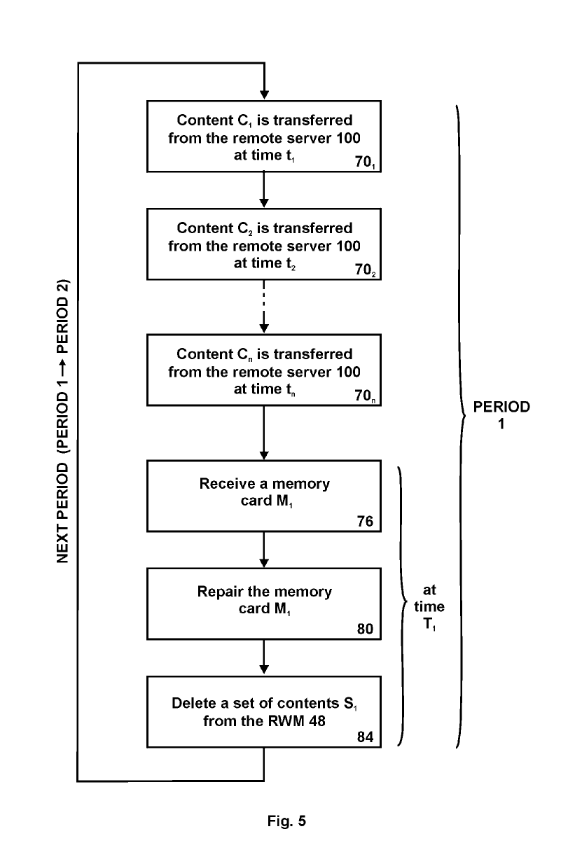

FIG. 5 discloses more details of a hybrid content-distribution method. It includes a number of publication periods (e.g. PERIOD 1 and PERIOD 2). Each publication period comprising similar steps. During PERIOD 1 (e.g. during the first two months), new contents, once released, are transferred from the remote server 100 to the playback device 30 with the communicating means 36. For example, content C₁ (e.g. movie 1) is transferred at time t₁ (step 70₁); content C₂ (e.g. movie 2) is transferred at time t₂ (step 70₂); . . . ; content Cₙ (e.g. movie n) is transferred at time tₙ (step 70ₙ). Here, new contents are either downloaded by the playback device 30 or pushed in by the remote server 100. The transferred contents are stored in the RWM 48. During PERIOD 1, the contents C₁, C₂, . . . Cₙ are accessed from the RWM 48.

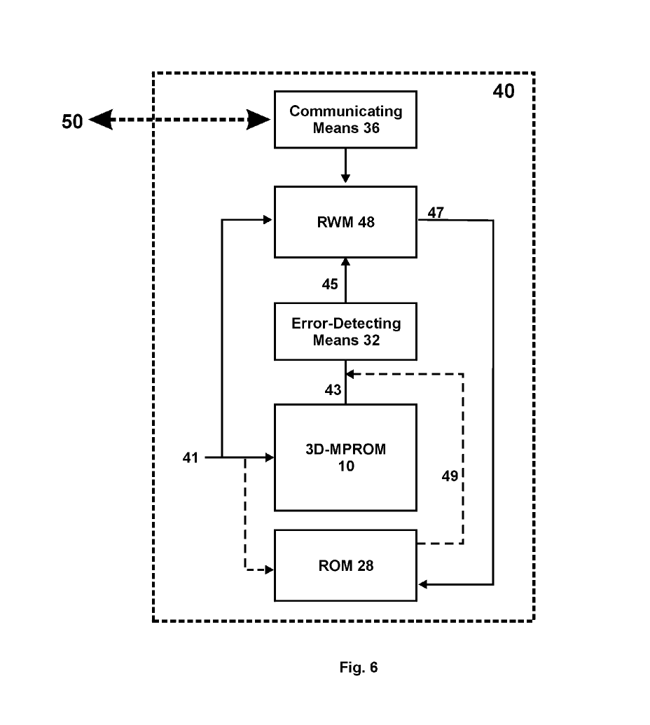

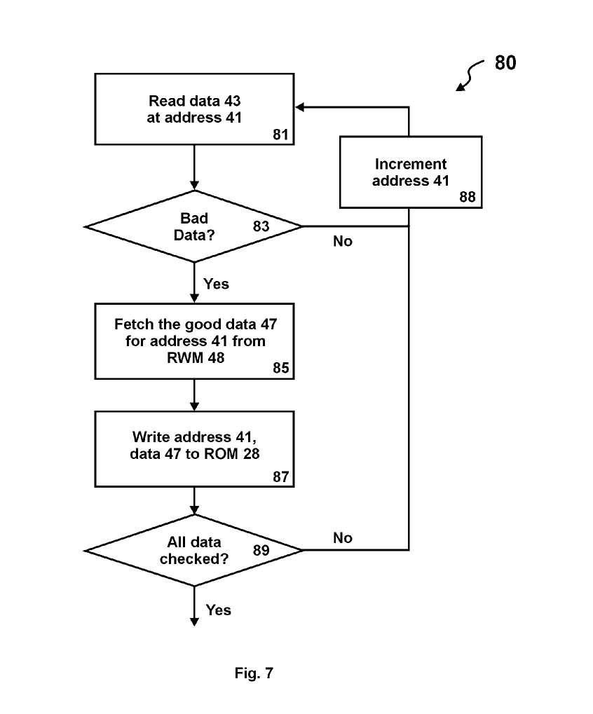

At the end of PERIOD 1, a first set of contents S₁ (=C₁+C₂+ . . . +Cₙ) is accumulated in the RWM 48. At time T₁, a user receives a first memory card M₁ (step 76), which permanently stores the first set of contents S₁. Note that, in order to reduce the testing cost, most of the 3D-MPROM data are not checked in the factory! Then a self-repair step is carried out to check and repair the 3D-MPROM data (step 80). The details of this self-repair step will be disclosed in FIGS. 6-7. Afterwards, the first set of contents S₁ is deleted from the RWM 48 (step 84). Because the RWM 48 is emptied now, PERIOD 2 could start. After PERIOD 1, the contents C₁, C₂, . . . Cₙ can be accessed from the memory card Mi.

In the above description, the self-repair step 80 is carried out in the field where the playback device 30 is used. After the memory card 20 is inserted into the playback device 30, the 3D-MPROM data are checked and repaired in one of the following situations: 1) when the playback device 30 is idle (i.e. idle repair); 2) when the memory card 20 is in use, more particularly during its 1^{st} use (i.e. 1^{st}-use repair). Generally speaking, after it is repaired, the memory card 20 no longer needs to be repaired again. It can be directly used in other playback devices, e.g. the one that does not have internet access.

FIG. 6 discloses more details of the preferred self-repair system 40. It comprises a 3D-MPROM 10, a read-only memory (ROM) 28, an error-detecting means 32, a re-writable memory (RWM) 48, and a communicating means 36. Details of these components will be explained in the following paragraphs.

The 3D-MPROM 10 stores the content data. The 3D-MPROM data should use a coding scheme that facilitates error-detection. In the present invention, this coding scheme is referred to as error-detection code. Preferably, this error-detection code can be used to correct errors. Overall, the error-detection code should be stronger in error detection than error correction. Its examples include Reed-Solomon code, Golay code, BCH code, multi-dimensional parity code, Hamming code, and convolutional code.

The ROM 28 functions as a redundancy memory for the 3D-MPROM 10. It stores the addresses of the bad data from the 3D-MPROM 10 and the associated good data. The ROM 28 could be a non-volatile memory that can be programmed at least once, e.g. a one-time-programmable memory (OTP), an EPROM memory, an EEPROM memory, or a flash memory. The redundancy ROM 28 is preferably located in a same memory card 20 as the 3D-MPROM 10. This way, the repaired memory card 20 can be used by other playback devices (including those without internet access). To read a repaired memory card 20, address 41 is first compared with those stored in the redundancy ROM 28. If there is a match, the data 49 from the ROM 28, instead of the data 43 from the 3D-MPROM 10, are read out. This is indicated by the dash lines of FIG. 6.

The error-detecting means 32 detects errors in the data 43 from the 3D-MPROM 10. Preferably it can also correct error(s). This error-detecting means 32 should use an error-detecting algorithm suitable for the coding scheme used by the 3D-MPROM data. The error-detecting means 32 can be located either in the memory card 20 or in the playback device 30.

The RWM 48 is part of the playback device 30 and it stores the contents transferred from the remote server 100 during each publication period. To make room for the contents to be released in the next publication period, the contents common to the 3D-MPROM 10 and the RWM 48 are deleted from the RWM 48 after each publication period. The RWM 48 is a non-volatile re-writable memory, e.g. a flash memory.

The communicating means 36 is part of the playback device 30. During a publication period, it incrementally transfers new contents from the remote server 100 to the RWM 48. The communicating means 36 includes internet, WiFi and cellular communication means.

FIG. 7 discloses more details of the self-repair step 80 of FIG. 5. First of all, the data 43 at address 41 are read out from the 3D-MPROM 10 (step 81). The error-detecting means 32 checks the data (step 83). If bad data are detected, an error-signal 45 is asserted and the good data 47 for the address 41 are fetched from the RWM 38 (step 85). Then the good data 47 and the address 41 are saved into the redundancy ROM 28 (step 87). In the present invention, the good data 47 and the address 41 are collectively referred to as redundancy information. The steps 81-87 are repeated for the incremented addresses 41 (step 88) until all data have been checked (step 89).

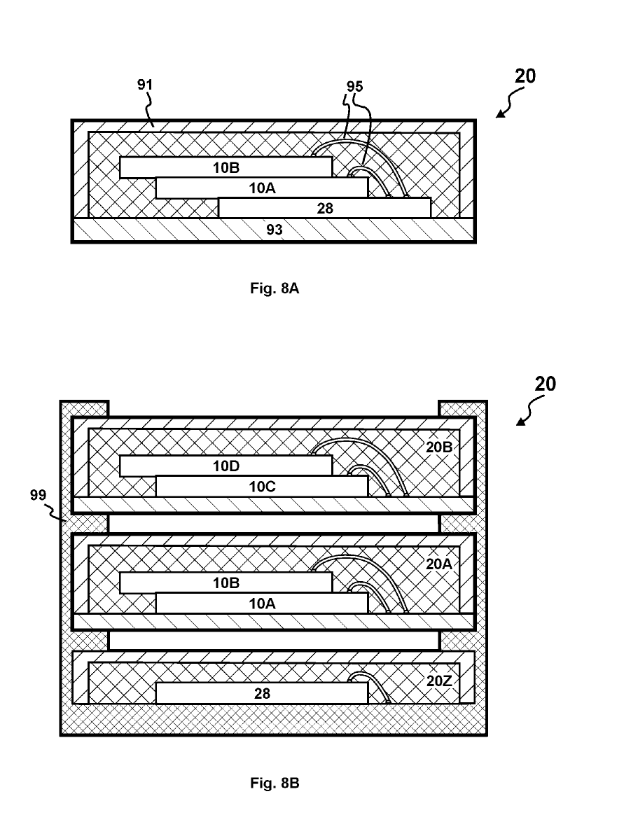

The memory card 20 could comprise a memory package or a memory module. FIG. 8A discloses a preferred memory card 20. It is a multi-die package. It comprises a plurality of vertically stacked 3D-MPROM dice 10A, 10B and a redundancy ROM die 28. These dice 10A, 10B, 28 are located in a package housing 91 and stacked on a package substrate (e.g. interposer) 93. Bond wires 95 provide electrical connection among the dice 10A, 10B, 28. In this preferred embodiment, a single redundancy ROM die 28 stores the redundancy information for a plurality of 3D-MPROM dice (e.g. 10A, 10B).

FIG. 8B discloses another preferred memory card 20. It is a multi-package module. It comprises a module frame 99 which holds a plurality of vertically stacked memory packages 20A, 20B, 20Z. Among them, the memory package 20A is a 3D-MPROM package and it comprises two vertically stacked 3D-MPROM dice 10A, 10B; the memory package 20B is a 3D-MPROM package and it comprises two vertically stacked 3D-MPROM dice 10C, 10D; the memory package 20Z comprises a redundancy ROM die 28. In this preferred embodiment, a single redundancy ROM die 28 stores the redundancy information for a plurality of packages 20A, 20B (including the 3D-MPROM dice 10A, 10B, 10C, 10D).

While illustrative embodiments have been shown and described, it would be apparent to those skilled in the art that may more modifications than that have been mentioned above are possible without departing from the inventive concepts set forth therein. Besides 3D-MPROM, the self-repair system and method can be applied to other mask-ROM. The invention, therefore, is not to be limited except in the spirit of the appended claims.

What is claimed is:

1. A self-repair system for a three-dimensional mask-programmable read-only memory (3D-MPROM), comprising:
a consumer processing apparatus comprising a re-writable memory (RWM);
a 3D-MPROM comprising a plurality of vertically stacked memory levels;
an error-detecting means for checking the 3D-MPROM data;
wherein, when said error-detecting means detects bad data from said 3D-MPROM, said consumer processing apparatus fetches the good data to replace said bad data from said RWM.

2. The self-repair system according to claim 1, wherein said consumer processing apparatus is a cellular phone, an internet TV, or a computer.

3. The self-repair system according to claim 1, wherein said RWM is a flash memory.

4. The self-repair system according to claim 1, wherein the 3D-MPROM data use an error-detection code.

5. The self-repair system according to claim 1, wherein said consumer processing apparatus further comprises a communicating means for transferring contents from a remote server to said RWM.

6. The self-repair system according to claim 1, further comprising a read-only memory (ROM) for storing the redundancy information for said 3D-MPROM.

7. The self-repair system according to claim 6, wherein said ROM stores the redundancy information for a plurality of 3D-MPROM dice.

8. A self-repair method for a three-dimensional mask-programmable read-only memory (3D-MPROM), comprising the steps of:
1) reading data from said 3D-MPROM;
2) checking data from said 3D-MPROM;
3) when bad data are detected, fetching the good data to replace said bad data from a re-writable memory (RWM);
wherein the steps 1)-3) are carried out by a consumer processing apparatus comprising said RWM.

9. The self-repair method according to claim 8, wherein said consumer processing apparatus is a cellular phone, an internet TV, or a computer.

10. The self-repair method according to claim 8, wherein said RWM is a flash memory.

11. The self-repair method according to claim 8, wherein the 3D-MPROM data use an error-detection code.

12. The self-repair method according to claim 8, further comprising the step of transferring contents from a remote server to said RWM before the step 1).

13. The self-repair method according to claim 8, further comprising the step of writing the redundancy information for said 3D-MPROM to a read-only memory (ROM) after the step 3).

14. A self-repair method for a mask-programmable read-only memory (mask-ROM), comprising the steps of:
1) reading data from said mask-ROM;
2) checking data from said mask-ROM;
3) when bad data are detected, fetching the good data to replace said bad data from a re-writable memory (RWM);
wherein the steps 1)-3) are carried out by a consumer processing apparatus comprising said RWM.

15. The self-repair method according to claim 14, wherein said mask-ROM is a three-dimensional mask-programmed read-only memory (3D-MPROM).

16. The self-repair method according to claim 14, wherein said consumer processing apparatus is a cellular phone, an internet TV, or a computer.

17. The self-repair method according to claim 14, wherein said RWM is a flash memory.

18. The self-repair method according to claim 14, wherein the 3D-MPROM data use an error-detection code.

19. The self-repair method according to claim 14, further comprising the step of transferring contents from a remote server to said RWM before the step 1).

20. The self-repair method according to claim 14, further comprising the step of writing the redundancy information for said 3D-MPROM to a read-only memory (ROM) after the step 3).
